(19) United States
(12) Patent Application Publication
(10) Pub. No.: US 2014/0123076 A1
(43) Pub. Date: May 1, 2014

(54) NAVIGATING AMONG EDIT INSTANCES OF CONTENT

(71) Applicant: MICROSOFT CORPORATION, Redmond, WA (US)

(72) Inventor: Jaimin Kirtikumar Gandhi, Redmond, WA (US)

(73) Assignee: MICROSOFT CORPORATION, Redmond, WA (US)

(21) Appl. No.: 13/665,994

(22) Filed: Nov. 1, 2012

(51) Int. Cl. G06F 3/048

(52) U.S. Cl. 715/854

(57) ABSTRACT

A user opens a tracked system and provides edit inputs into the system. The edit inputs are logically grouped to create an edit instance. User interface elements in the edit instance are given a sequential identifier to distinguish them from previous and subsequent edit instances. The user can view the edit instances, in chronological order, based upon the sequential identifiers assigned to the different edit instances.

### BACKGROUND

There are currently a wide variety of different types of software systems or applications that allow users to provide inputs to create and edit content. For example, a word processing application allows a user to input text to create a document. A spreadsheet program allows a user to configure cells in a grid in order to create a spreadsheet and fill it with content. Note taking applications (including collaborative note taking applications) allow one or more individual users to set up notebooks (such as notebooks corresponding to different subjects) and to put information, such as notes, figures, etc. into each of the notebooks. Drawing programs allow users create various drawings or diagrams, and other systems allow users to input content in various forms as well. Each of these types of systems also allows a user to add new content, modify the content once it is input, or even to delete it.

Once the content in such a system has been created, the user often wishes to go back and review the content. There is currently almost no way for a user to go back and review the chronology in which content was added, deleted or in which edits were made. Many times, however, reviewing the order of the flow of thoughts (such as the chronology in which the content was added and edited) can be almost as important as thoughts (e.g., the content) themselves.

By way of example, assume that a student is taking notes in a note taking application for a class. Assume that the student then adds a figure or drawing, provided by a professor during a lecture, to the notes and then takes notes on the drawing, as the professor continues to lecture. Assume that the professor is deliberately lecturing on different parts of the drawing, in a specific chronology or order. That is, the instructor may describe the last part of the drawing first, and then go back and fill in a description of the remaining parts of the drawing. It may be helpful to be able to recount the order in which the instructor described the drawing, as well as to see what the instructor actually said (i.e., as well as to be able to read the notes that the student took, themselves). This problem has not been well addressed in conventional systems.

The discussion above is merely provided for general background information and is not intended to be used as an aid in determining the scope of the claimed subject matter.

### SUMMARY

A user opens a tracked system and provides edit inputs into the system. The edit inputs are logically grouped to create an edit instance. User interface elements in the edit instance are given a sequential identifier to distinguish them from previous and subsequent edit instances. The user can view the edit instances, in chronological order, based upon the sequential identifiers assigned to the different edit instances. The user can also make changes to the edit instances or write comments or otherwise enhance the quality of the content in the system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one embodiment of an edit tracking system.

FIG. 2 is a flow diagram illustrating one embodiment of the operation of the system shown in FIG. 1 in creating edit instances.

FIG. 2A is a block diagram of one illustrative edit instance.

FIG. 3 is a flow diagram illustrating one embodiment of the operation of the system shown in FIG. 1 in navigating through various edit instances in a tracked system.

FIGS. 3A-3D show various embodiments of user interface displays.

FIG. 4 is a block diagram of one embodiment of the edit tracking system in various architectures.

FIGS. 5-9 show various embodiments of mobile devices.

FIG. 10 is a block diagram of one illustrative computing environment.

### DETAILED DESCRIPTION

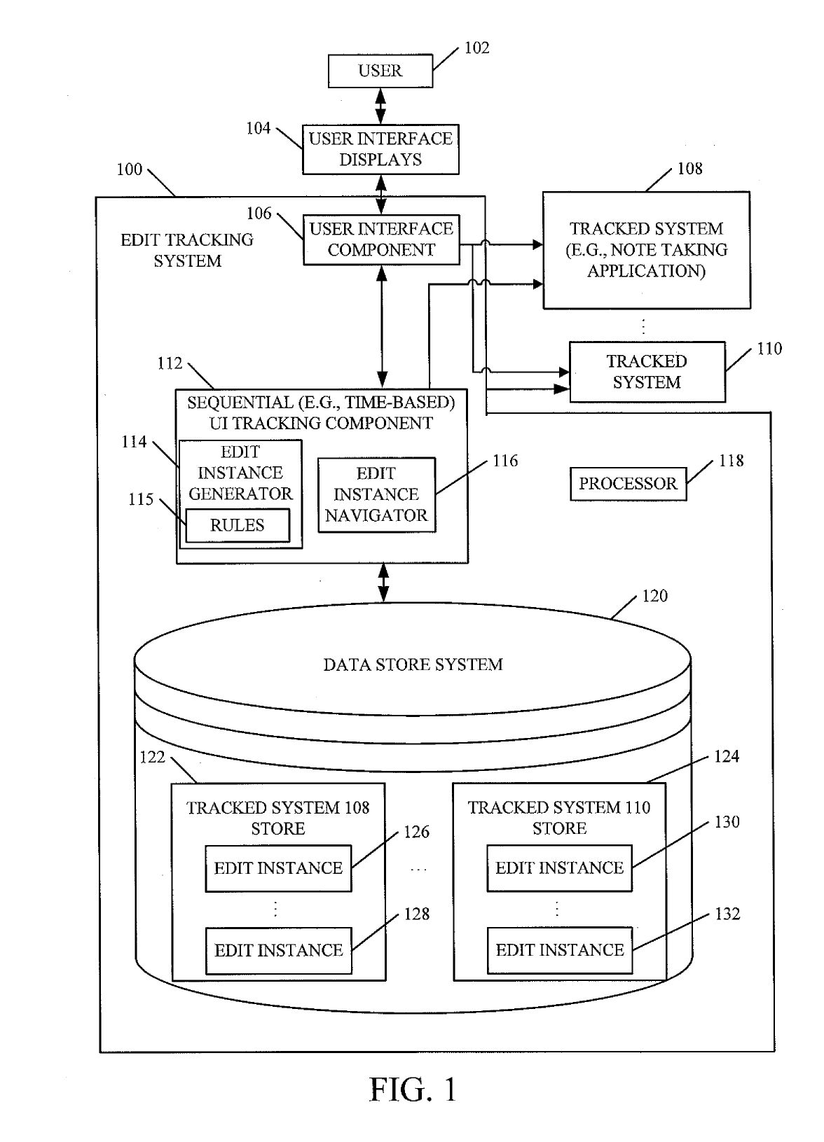

FIG. 1 is a block diagram of one embodiment of edit tracking system 100. Edit tracking system 100 is shown being accessed by user 102 through user interface displays 104. FIG. 1 also shows that edit tracking system 100 has access to tracked systems 108 and 110. In one embodiment, tracked systems 108 and 110 are systems that allow a user to create, and make edits to, content. For instance, tracked systems 108-110 can be any of a variety of systems, including but not limited to, word processing systems, drawing systems, note taking applications, spreadsheet applications, operating systems, or a wide variety of other systems.

In addition, tracked system 108-110 could include a business data system, such as a customer relations management (CRM) system, an enterprise resource planning (ERP) system a line-of-business (LOB) application or another business data system. These types of business data systems often include business data records for entities, such as customers, accounts, products, inventory, sales, personnel, invoices, quotes, proposals, and other business data. Tracked systems 108-110 could include consumer data systems such as a social network or a news portal or even a user's hard drive, for example. These are described in greater detail below.

In the embodiment discussed herein, tracked system 108 is illustratively a note taking application that enables user 102 to generate, through user interface displays 104, a plurality of different notebooks each corresponding, for example, to a different subject. User 102 can then navigate to the individual notebooks and take notes and also add other content, such as video clips, drawings, or other content provided by an instructor, etc. The note taking application can be a collaborative note taking application in which a plurality of different users can all access the same notebooks. Therefore, while the present discussion will proceed with respect to tracked system 108 being a note taking application, it will be appreciated that this is described by way of example only, and it could be a wide variety of other applications or software systems as well.

FIG. 1 shows that edit tracking system 100 also includes sequential (e.g., time-based) tracking component 112, that, itself, includes edit instance generator 114 and edit instance navigator 116. System 100 also includes processor 118 and data store system 120. Data store system 120 illustratively includes a separate data store for each of the tracked systems 108 and 110. Therefore, data store system 120 includes tracked system 108 data store 122 and tracked system 110 data store 124. Each data store 122 and 124 within data store system 120 includes a plurality of edit instances corresponding to the given tracked system. For instance, data store 122 includes edit instances 126 and 128 that correspond to edits made within tracked system 108. Data store 124 includes edit instances 130 and 132 that reflect edits made in tracked system 110. It will be appreciated that data store system 120 can be one or more separate database systems or other data store systems that are stored locally with respect to edit tracking system 100 or remotely therefrom. In addition, data store system 120 could be a plurality of different database systems some of which are stored locally and some of which are stored remotely and accessible over a network, such as the Internet.

Also, in one embodiment, processor 118 is illustratively a computer processor with associated memory and timing circuitry (not separately shown). Processor 118 is illustratively a functional part of edit tracking system 100 and facilitates the functionality of other components or systems in edit tracking system 100. In addition, it will be noted that only a single processor 118 is shown by way of example. However, processor 118 could also be a plurality of different processors, in each of the different components or items in edit tracking system 100. Further, all of the items could be implemented as a system on a chip, or otherwise reduced to hardware, and they are shown as separate items for the sake of example only.

Before describing the operation of system 100 in more detail, a brief overview will be given for the sake of enhanced understanding. User 102 illustratively opens one of tracked systems 108-110. For the sake of example, the particular tracked system opened by user 102 will be described as a note taking application that comprises tracked system 108. It will be noted that system 100 can have multiple users of a tracked system, such as collaborative note taking systems or document management systems as well.

User 102 then makes edits within note taking application 108. User 102 can illustratively do this through user interface displays 104 that provide user input mechanisms that allow user 102 to access and manipulate system 100 and tracked systems 108-110. The user input mechanisms can be any of a wide variety of user input mechanisms, such as buttons, links, text boxes, dropdown menus, etc., and they can receive inputs from user 102 in a variety of different ways. For instance, user 102 can provide inputs with a point and click device (such as a track ball or mouse) using a hardware or soft keyboard or keypad, or using voice inputs, etc. In addition, where the display device used to display user interface displays 104 is a touch sensitive screen, user 102 can provide inputs using touch gestures with the user's finger, a stylus, a pen, or another input device. These are described by way of example only.

Once the user makes edits to the note taking application 108, edit instance generator 114 (in sequential UI tracking component 112) logically groups the edit inputs into an edit instance and assigns the edit instance a sequential identifier (e.g., a time stamp) and stores it as an edit instance in data store 122. This is repeated as edit inputs are received to obtain a plurality of edit instances. When the user later wishes to view a sequential reconstruction of how the edits were made within note taking application 108, the user 102 illustratively accesses edit instance navigator 116 in sequential UI tracking component 112 to view the edit instances 126-128 in data store 122 in a sequential order, or otherwise based on the sequential identifier given to each of the edit instances. In this way, the user can easily see how the content in note taking application 108 was generated, added, deleted, modified, or otherwise changed over time (e.g., based on the sequential identifier).

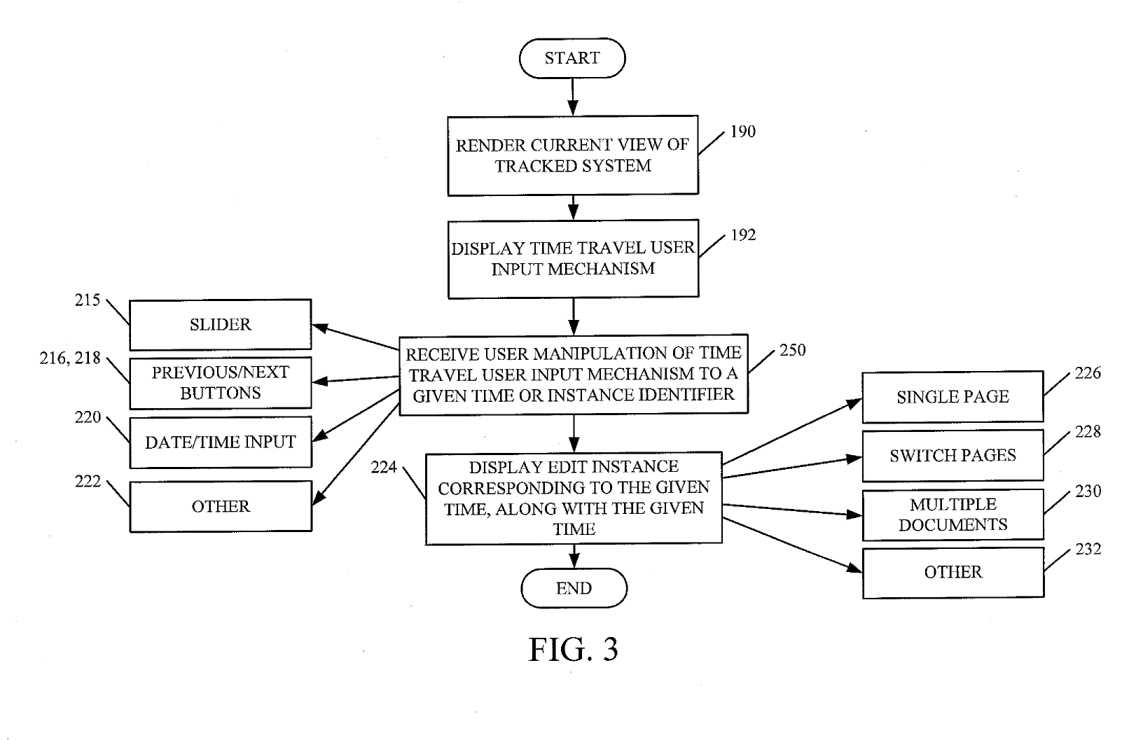

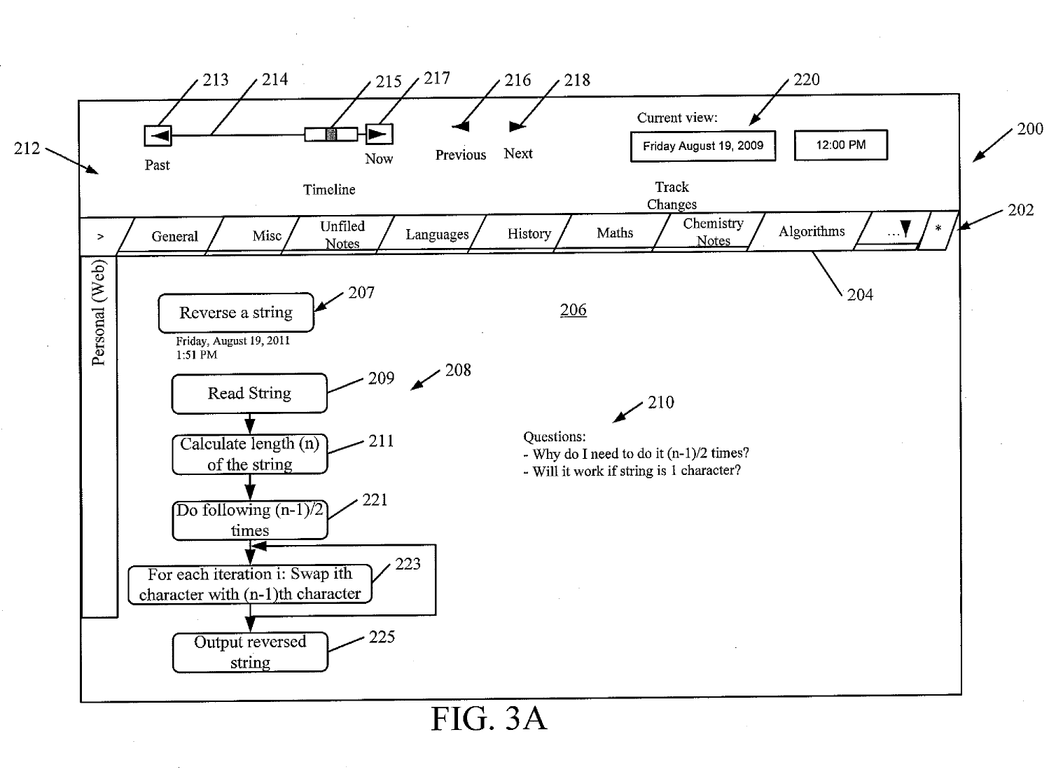

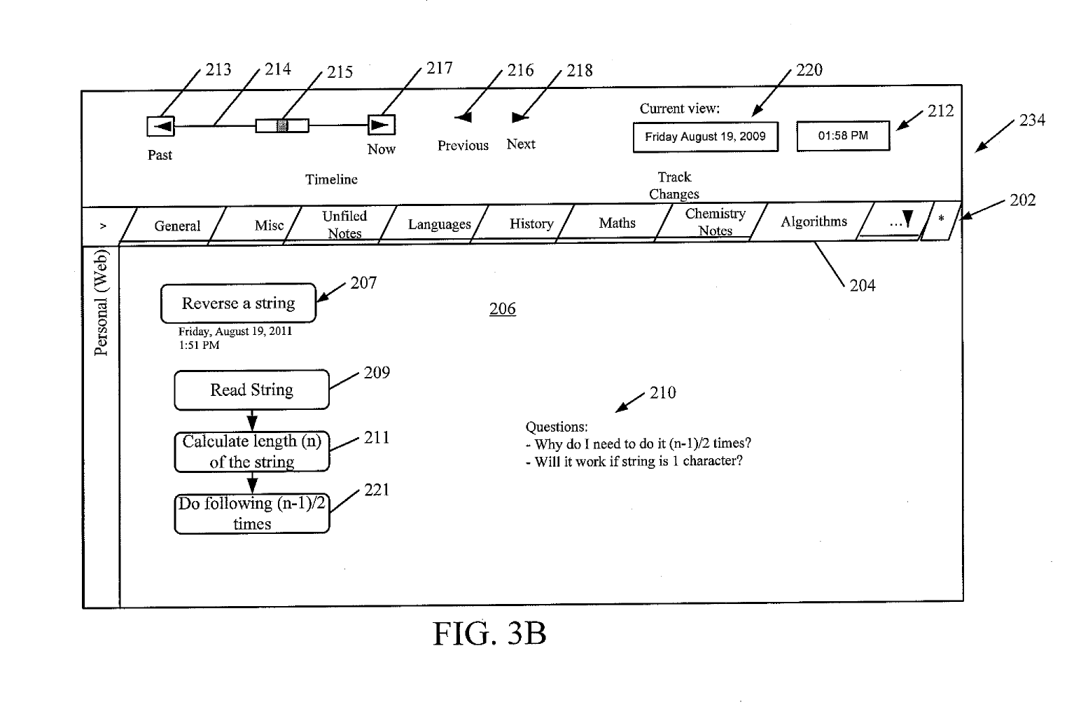

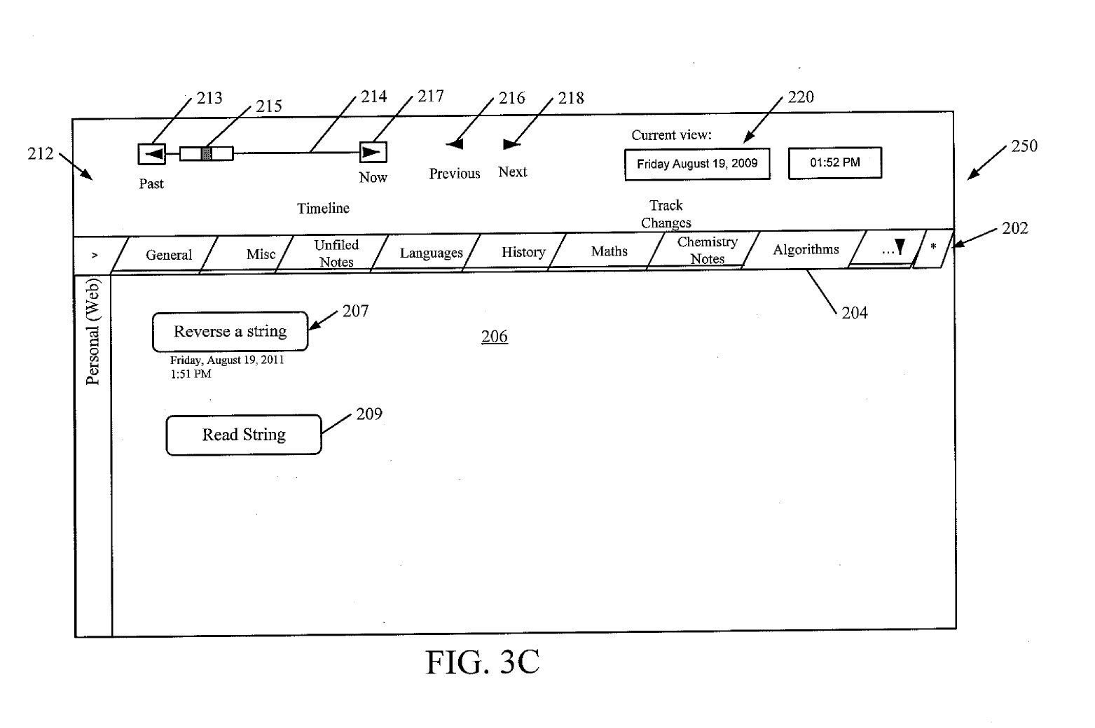

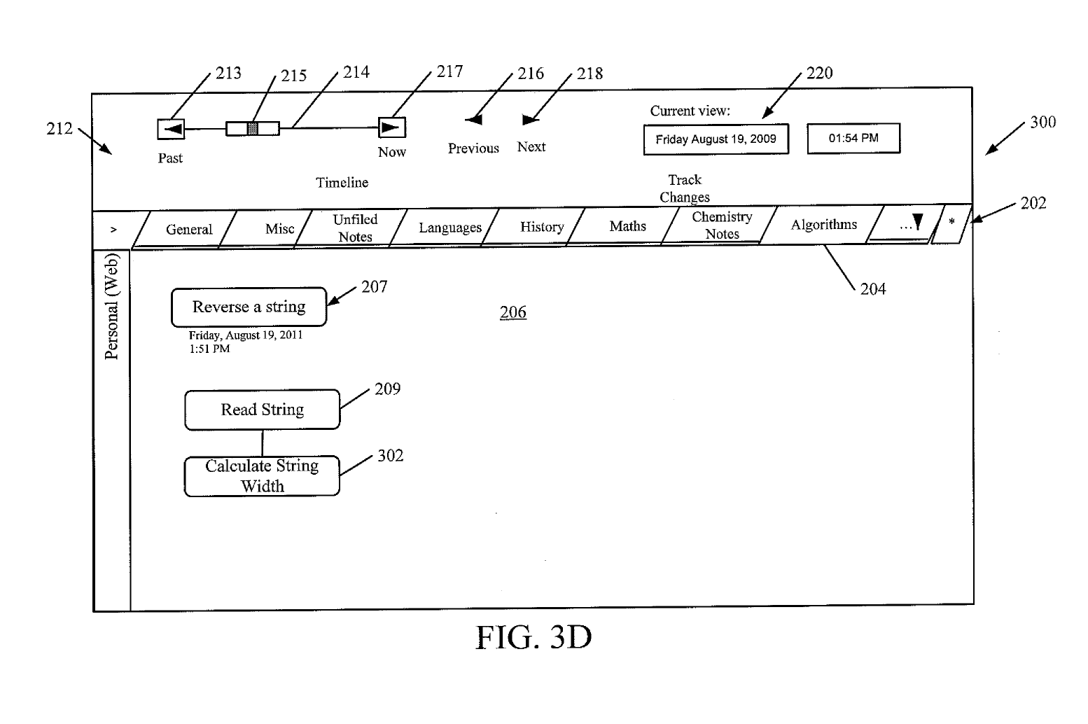

The view is a collection of all UI elements that are rendered (shown to the user 102) for a particular instant of time. For example, if a user creates two text boxes, one on Mar. 19, 2012 at 1:00 pm PST and a second on Mar. 19, 2012 at 1:01 pm PST, the user may wish to open the document and see both text boxes in a current view. However, if the user flips back to the view created on Mar. 19, 2012 at 1:00 pm, the user sees only the first text box. This is described in greater detail below with respect to FIGS. 3-3D.

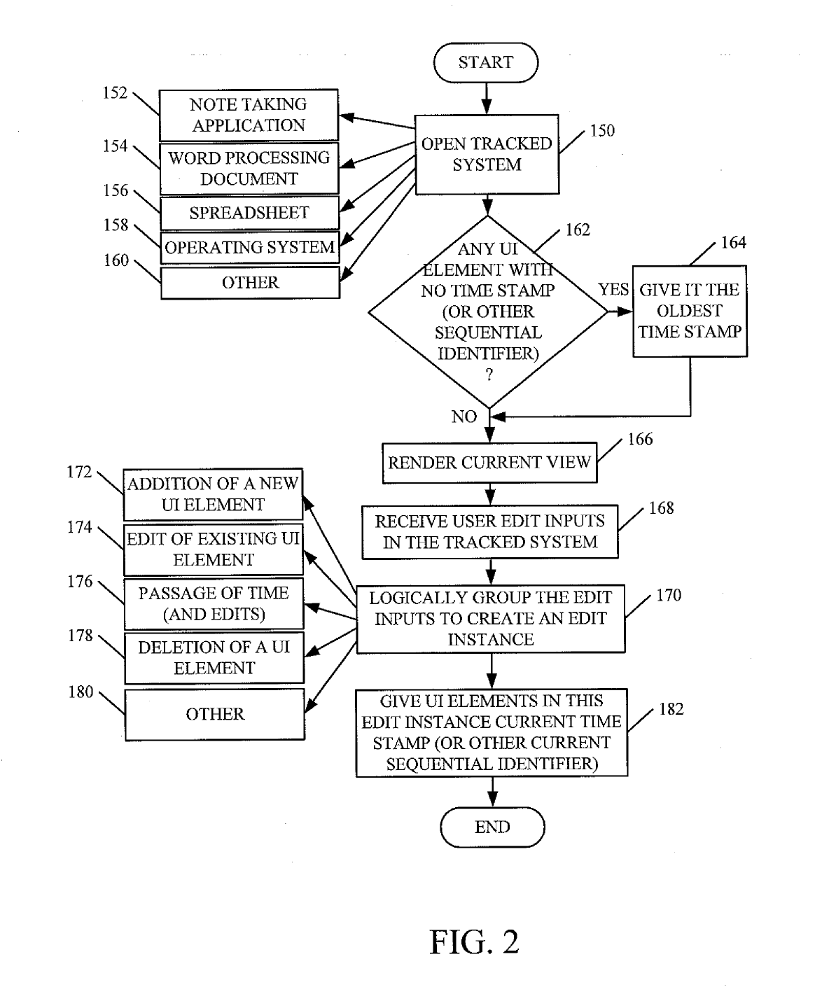

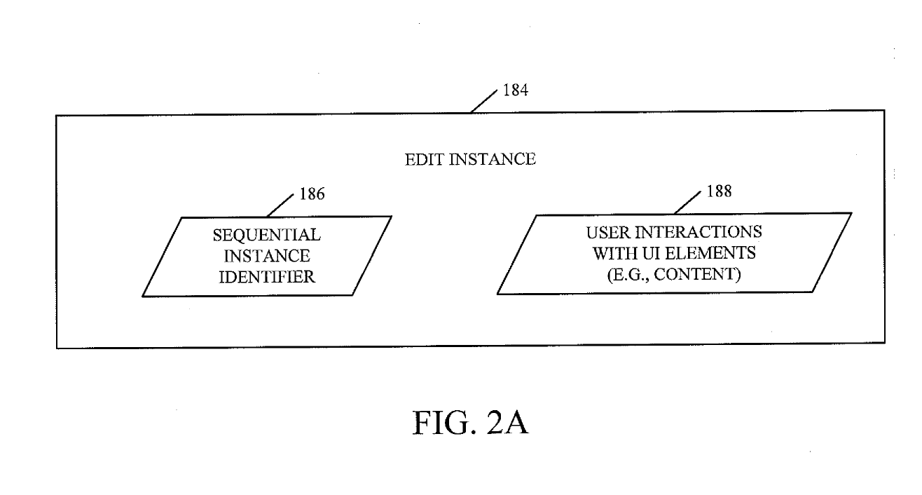

FIG. 2 is a flow diagram illustrating the overall operation of edit tracking system 100, shown in FIG. 1, in creating a new edit instance (such as one of edit instances 126-128 in data store 122). User 102 first opens one of the tracked systems 108-110. This is indicated by block 150 in FIG. 2. As discussed above, the tracked systems can include a note taking application 152, word processing document 154, spreadsheet 156, operating system 158 or another tracked system 160. The discussion will proceed with respect to the open, tracked system being a note taking application 152.

It may happen that the note taking application 152 was created before the edit instances were being tracked by edit tracking system 100. Therefore, component 112 first determines whether any of the UI elements in note taking application 152 are without a sequential identifier (such as a time stamp). This is indicated by block 162 in FIG. 2. A UI element is a single unit of interface control that a user can interact with. For instance, a UI element may include a text box, an inserted image, a hyperlink, a button, a link object, etc. In any case, if component 112 determines that any UI element in note taking application 152 does not have a sequential identifier, then component 112 assigns the UI element the oldest sequential identifier that currently exists. This is indicated by block 164 in FIG. 2. For instance, where the sequential identifier is a time stamp, component 112 gives the UI elements (that have no sequential identifier) the oldest time stamp corresponding to any edit instance in note taking application 152. If there are no previous edit instances, then component 112 gives all UI elements in note taking application 152 the current time stamp.

Once component 112 determines that all of the UI elements in note taking application 152 have a sequential identifier, then user interface component 106 renders a current view of note taking application 152. This is indicated by block 166 in FIG. 2. Note taking application 152 then receives user edit inputs in the note taking application 152. This is indicated by block 168. For instance, user 102 may modify or add text to the current view, add images, insert or delete other information, or provide other editing inputs.

In response to the editing inputs, edit instance generator 114 logically groups the edit inputs to create a new edit instance. This is indicated by block 170 in FIG. 2. It will be noted that edit instance generator 114 can logically group the edit inputs into edit instances in a variety of different ways. This can be done according to a set of edit instance generation rules 115 which can be predetermined rules, user-defined rules, user-selectable rules, or other rules. Each edit instance represents the set of UI elements on a given view of the note taking application 152 at a given time.

For instance, in one embodiment, edit instance generator 114 can treat the addition of any new UI element as an event (based on rules 115) indicating that a new edit instance is to be generated. This is indicated by block 172 in FIG. 2. Edit instance generator 114 can also access a rule 115 that indicates that a new edit instance should be generated if any of the existing UI elements are edited by user 102. This is indicated by block 174. In addition, edit instance generator 114 can group sets of edit inputs by user 102 based on time. By way of example, if the user is editing a view or a page or multiple pages in note taking application 152, edit instance generator 114 can group those edits into groups of edits made every five minutes and create new edit instances for the edits made during each five minute period, instead of for every single edit. Generating new edit instances based on the passage of time and edits input by user 102 is indicated by block 176 in FIG. 2. The amount of time between generation of new edit instances can be determined empirically, by user experience studies, it can be set arbitrarily, or otherwise.

Edit instance generator 114 can also access a rule 115 that indicates that a new edit instance should be generated if any of the UI elements on the current view are deleted. This is indicated by block 178. Of course, a wide variety of other rules for generating new edit instances can be used as well, and this is indicated by block 180 in FIG. 2.

Once the UI elements and edits are grouped into a new UI edit instance, edit instance generator 114 gives each UI element in the edit instance the current sequential identifier (such as the current time stamp). This is indicated by block 182 in FIG. 2. If a UI element already existed and had a sequence identifier in a previous edit instance, a new instance of the same element is created and given the new sequence identifier. In this way, it is even possible to track changes within the same given UI element.

FIG. 2A shows one illustrative block diagram of a new edit instance 184. New edit instance 184 illustratively includes the sequential instance identifier 186 and user interactions with UI elements (e.g., the content of the UI element) 188. It can be seen that the edit instance 184 is illustratively a list of user interactions on the UI elements within a given period of time (or using whatever other rule is used to group edits into an edit instance) which are grouped logically in a way that the user perceives them as a single edit. For instance, if the user creates a text box and enters some text inside the text box, the two actions could be grouped as a single edit instance. Of course, they could be grouped separately as well.

FIG. 3 is a flow diagram illustrating one embodiment of the operation of edit instance navigator 116 in navigating among the various edit instances 126-128 that are stored for the tracked system (such as for the note taking application 152). When user 102 launches note taking application 152, user interface component 106 renders a current view of note taking application 152. This is indicated by block 190 in FIG. 3. Edit instance navigator 116 also displays a time travel user input mechanism (or a navigation or display sequence user input mechanism), and this is indicated by block 192 in FIG. 3.

FIG. 3A is a user interface display 200 that is provided by way of example. It can be seen that, in the embodiment shown in FIG. 3A, the user has opened a note taking application that has a set of tabs generally indicated at 202, each corresponding to a different notebook. It can be seen that the user has selected the algorithm tab 204 to show a notebook, and has opened the notebook to a page of algorithms, and corresponding notes. FIG. 3A shows that the note page (or content page) 206 being displayed includes a title box (or UI element) 207 and a flow diagram 208 and a set of textual notes 210. In one embodiment, title box 207 and each of the boxes or blocks (209, 211, 221, 223 and 225) in flow diagram 208 and the corresponding texts, are considered a UI element. Similarly, each of the lines of text in notes 210 is also considered a UI element. Of course, as discussed above with respect to FIG. 2, edit instances for the content on pane 206 can be groups of edits that are grouped according to a wide variety of different types of rules, and some of those are discussed above with respect to FIG. 2.

It can also be seen in user interface display 200 that the time travel user input mechanism is illustrated generally at 212, as a menu or ribbon that includes a display of a timeline 214, slider 215 (that can be actuated by the user and moved to slide along timeline 214) previous and next buttons 216 and 218, respectively, and current view identifier 220.

Once display 200 is shown, edit instance navigator 116 illustratively receives a user input manipulating the time travel user input mechanisms 212 to a given time or sequence or instance identifier. This is indicated by block 250 in FIG. 3.

The user can illustratively actuate or manipulate the time travel user input mechanism 212 in a wide variety of different ways. For instance, if the display screen displaying the user interface that contains the time travel user input mechanism 212 is a touch sensitive screen, the user can simply use touch gestures with the user's finger, with a stylus, with a pen, or in other ways. Of course, the user can also use a point and click device such as a trackball or computer mouse. Similarly, the user can illustratively use a soft or hardware keyboard or keypad. The user can also illustratively use voice inputs or other mechanisms for manipulating the time travel input mechanism 212. These are given by way of example only.

In the embodiment shown in FIG. 3A, the user can manipulate one of a plurality of the different user input mechanisms in order to move backward and forward among the sequential edit instances that have been saved for the present application. For instance, user 102 can move slider 215 along timeline 214. It can be seen that timeline 214 has a “now” end with actuator 217 and a “past” end with actuator 213. As the user moves slider 215 between the two ends, the edit instances which were created, and that correspond to each position on the timeline, are displayed on content pane 206.

The user can navigate among the edits instances in other ways as well. When the past end actuator 213 is actuated by the user, slider 215 automatically moves all the way to the left on timeline 214. When actuator 217 is actuated, slider 215 is automatically moved all the way to the right on timeline 214. Based upon the position of slider 215 on timeline 214, the corresponding view (containing the edit instance corresponding to that position on timeline 214) is displayed on pane 206. Also, in one embodiment, the date and time (or other sequential identifier) that the currently-displayed edit instance was generated are displayed in display element 220, so that the user knows the date and time (or other sequential identifier) corresponding to the edit instance that is currently being viewed in pane 206.

User 102 can also manipulate the time travel user input mechanism 212 using the previous and next button 216 and 218. For instance, when the user is viewing a current view and clicks the previous buttons 216, edit instance navigator 116 will display the view corresponding to the previous edit instance, in sequential order. As the user continues to press the previous button 216, edit instance navigator 116 displays the next previous edit instance, with each click. The same is true as user 102 clicks the next button 218. That is, edit instance navigator 116 displays the next subsequent edit instance with each click.

In addition, in one embodiment, user 102 can change what view is being presented by entering, textually, a date and time in a user input mechanism comprising time display UI element 220. In that case, edit instance navigator 116 identifies the edit instance closest to the input date and time and displays that edit instance. Similarly, the user can illustratively use other means of navigating through the edit instances. For instance, in one embodiment, a dropdown menu is provided that lists the edit instances in sequential order. The user can simply select an edit instance from the dropdown menu and the corresponding view will be displayed. The other types of manipulating the time travel user input mechanism 212 are indicated by block 222 in FIG. 3.

Once the user 102 has manipulated the time travel user input mechanism 212, edit instance navigator 116 retrieves the appropriate edit instance from the appropriate data store in data store system 120 and the edit instance, and the corresponding time and date on which the edit instance was created, are displayed. This is indicated by block 224 in FIG. 3.

A number of additional things should be noted. For instance, the sequential edit instances can be generated for a single page displayed in the tracked system (such as a single page in note taking application 154). This is indicated by block 226 in FIG. 3. In that case, the edit instance navigator 116 will simply show the edit instances that were created for a given page as the user navigates among them.

However, it may also be that user 102 is flipping between pages in note taking application 152, or in another tracked system, and making edits. In that case, sequential edit instances may reside on different pages. Therefore, as the user navigates among the edit instances, the tracked system is controlled so that it displays different pages that correspond to the edits made by the user, in sequential order. For instance, if the user was first editing page 1 of the notes and then flipped to page 5 of the notes (or even a different section in a different notebook) then as the user navigates among the edit instances created in the note taking application 152, the different pages or sections can be displayed, as the user navigates among the edit instances. Switching pages in this fashion, as the user navigates through edit instances, is indicated by block 228 in FIG. 3.

It may also be that the user is making changes among a variety of different documents. It may also be that edit instance generator 114 generates edit instances for each of the multiple different documents in a single tracked system and groups them together. For instance, where the tracked system is a word processing application, it may be that user 102 is opening and closing (or navigating back and forth between) two or more different documents and making changes. In one embodiment, edit instance generator 114 sequentially identifies the edit instances generated for all of the different documents accessed by the user. Therefore, as the user navigates among the various edit instances, the different documents can be opened and displayed, as corresponding to a selected edit instance which the user 102 has selected for viewing. Multiple documents are indicated by block 230 in FIG. 3.

Of course, the edit instances may be generated for other tracked systems, such as for an operating system. For example, the user may change settings on an operating system over time. An edit instance can be generated each time the user changes settings. As the user navigates among the edit instances created for the operating system, the settings can change back and forth and be displayed, as desired. In the embodiment where an operation system is used, the user can navigate through edit instances to determine which programs were open in which sequence and at what times. This is indicated by block 232 in FIG. 3.

FIGS. 3B, 3C and 3D are user interface displays 234, 250 and 300, respectively, which show an embodiment in which the user is navigating among edit instances generated in the algorithms notebook 204 for which the current view is shown in FIG. 3A. Similar items are similarly numbered to those shown in FIG. 3A.

FIG. 3B shows that user 102 has moved slider 221 from the “now” end 223 toward the past end 213. In response, edit instance navigator 116 retrieves and displays (using user interface component 106) the view corresponding to the edit instance made at that time. It can also be seen that the time display in element 220 has now changed from Friday, Aug. 26, 2009 12:00 pm to Friday, Aug. 19, 2009 at 1:58 pm. Therefore, the view now shown on content pane 206 only includes boxes 209, 211 and 221, as well as notes 210. This is how the user interface display looked at the displayed time. Boxes 223 and 225 had not yet been placed on the page.

FIG. 3C shows yet another user interface display 250. In user interface display 250, similar items are similarly numbered to those shown in FIGS. 3A and 3B. It can be seen in FIG. 3C that the user has moved slider 215 further backward along timeline 214. The corresponding date is now displayed in element 220 as Friday, Aug. 19, 2009 at 1:52 pm. FIG. 3C shows that the only UI element displayed on the page is UI element 209 and title UI element 207. Boxes 211 and 221, as well as notes 210, had not yet been entered on the page at the displayed date and time. Therefore, the edit instance corresponding to the displayed date and time includes only UI elements 207 and 209.

FIG. 3D shows yet another user interface display 300. User interface display 300 shows that the user has moved slider 215 to a position between those shown in FIGS. 3B and 3C. In addition, the corresponding time displayed in element 220 is now Aug. 19, 2009 at 1:54 pm. Therefore, edit instance navigator 116 retrieves an edit instance that resides between the two shown in FIGS. 3B and 3C. It can be seen in FIG. 3D that a box 302 was initially added after block 209 shown in FIGS. 3B and 3C, but that it was deleted and replaced by block 211 shown in FIG. 3B. Therefore, FIG. 3D shows that the user can now see that he or she initially, incorrectly added a block to the flow diagram but then deleted it and replaced it with a different block. Because the edit instance was generated when the UI element corresponding to block 302 was created, this information is preserved for the user, and may enhance the user's understanding as he or she is reviewing the development of the content, by reviewing the sequentially arranged edit instances. Also, the user can choose to print the document at that particular edit instance.

It will be appreciated, of course, that if the user deletes a UI element, it is marked as deleted so that it does not appear in subsequent views. The UI element is not deleted, itself, so that it can be viewed when the appropriate prior edit instances (ones created while it existed) are displayed.

It may also be that a user wishes to remove all timeline information from a document. In that embodiment, the user is provided with a suitable user interface mechanism which, when actuated, flattens the document by removing all timestamp information from the UI elements. This may be, for instance, in order to enhance privacy or due to size constraints or for another reason.

As briefly mentioned above, tracked system 108 can be a social network system. Such a system allows the user to make edits to profile information, add or delete friends, send messages, etc. In that embodiment, system 100 allows the user to group logical user actions into edit instances. The user can then enter a date and view the status of the user's wall as of the entered date. Similarly, the tracked system 108 can be a news portal. The user can enter a date and see the status and contents of the news portal home page as of the entered date. If the tracked system 108 is a user's hard drive, the user can enter a date and see the status and contents of a folder, the desktop or other portion of the hard drive as of the entered date. These are exemplary only.

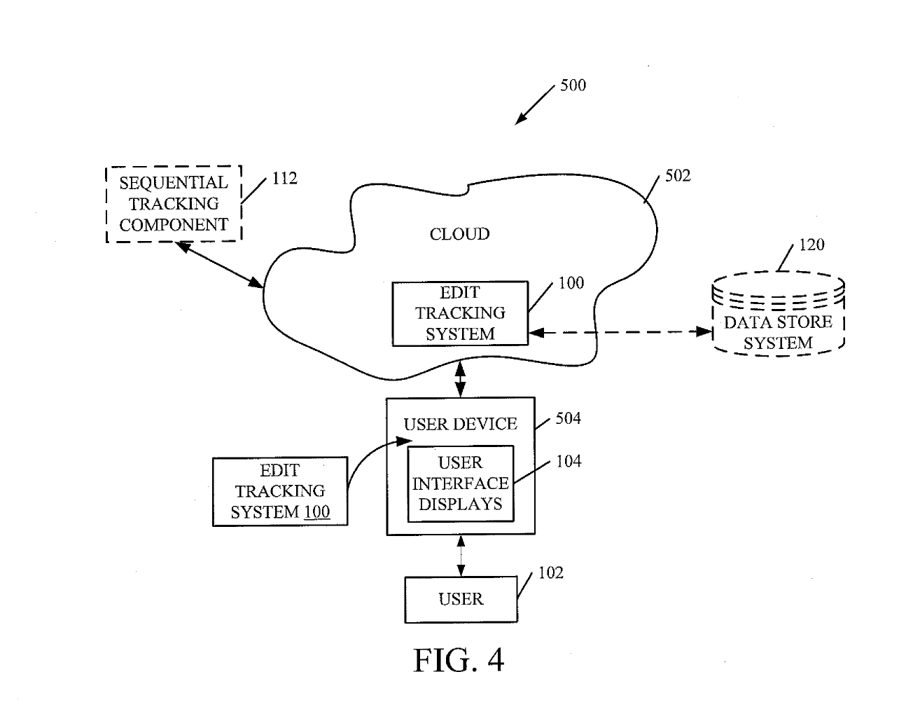

FIG. 4 is a block diagram of system 100, shown in FIG. 1, except that it is disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of system 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 4, some items are similar to those shown in FIG. 1 and they are similarly numbered. FIG. 4 specifically shows that system 100 is located in cloud 502 (which can be public, private, or a combination where portions are public while others are private). Therefore, user 102 uses a user device 504 to access those systems through cloud 502.

FIG. 4 also depicts another embodiment of a cloud architecture. FIG. 4 shows that it is also contemplated that some elements of system 100 are disposed in cloud 502 while others are not. By way of example, data store system 120 can be disposed outside of cloud 502, and accessed through cloud 502. In another embodiment, sequential tracking component 112 is also outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that system 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

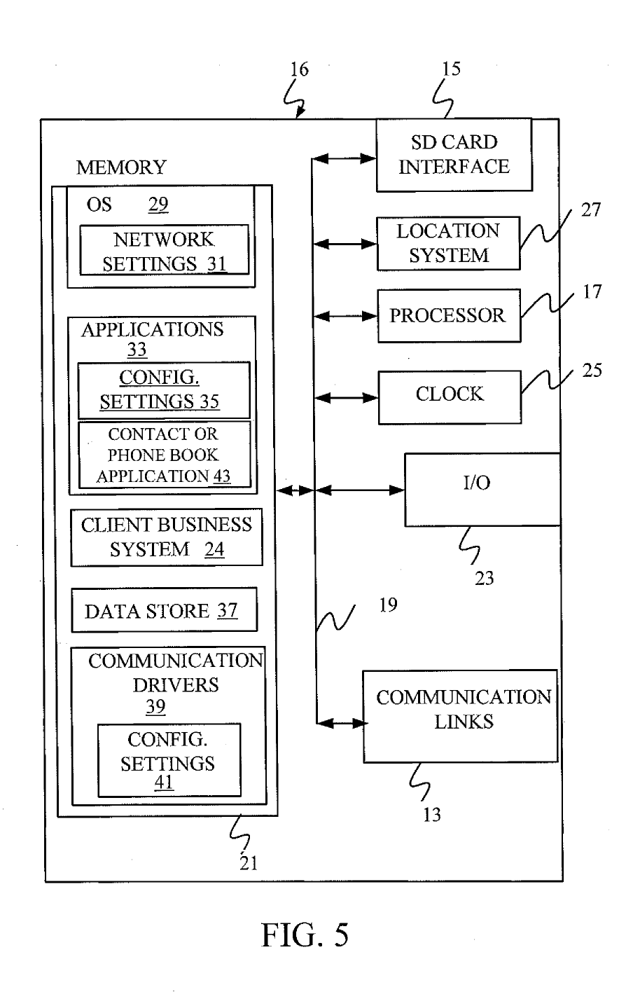

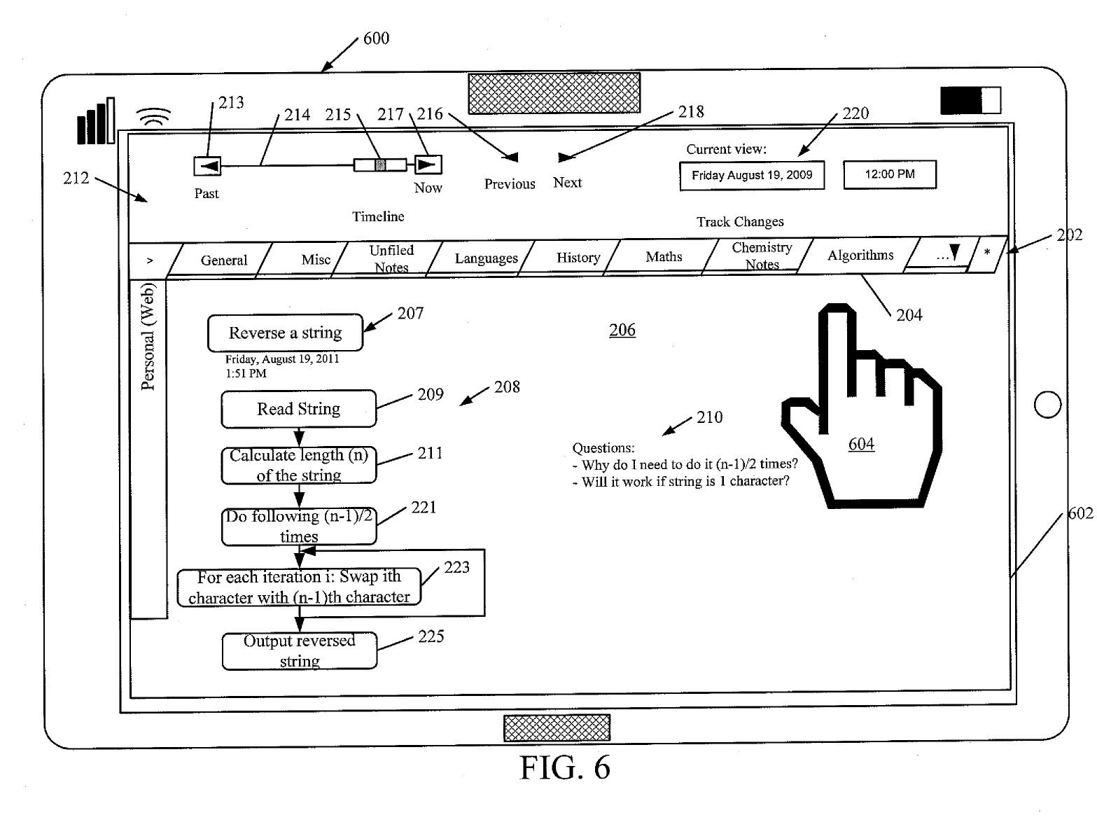

FIG. 5 is a simplified block diagram of one illustrative embodiment of a handheld or mobile computing device that can be used as a user's or client's hand held device 16, in which the present system (or parts of it) can be deployed. FIGS. 6-9 are examples of handheld or mobile devices.

FIG. 5 provides a general block diagram of the components of a client device 16 that can run components of system 100 or that interacts with system 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems (like system 100) are received on a removable Secure Digital (SD) card that is connected to a SD card interface 15. SD card interface 15 and communication links 13 communicate with a processor 17 (which can also embody processors 108 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. System 100 or the items in data store system 120, for example, can reside in memory 21. Similarly, device 16 can have a client business system 24 which can run various business applications or embody parts or all of system 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

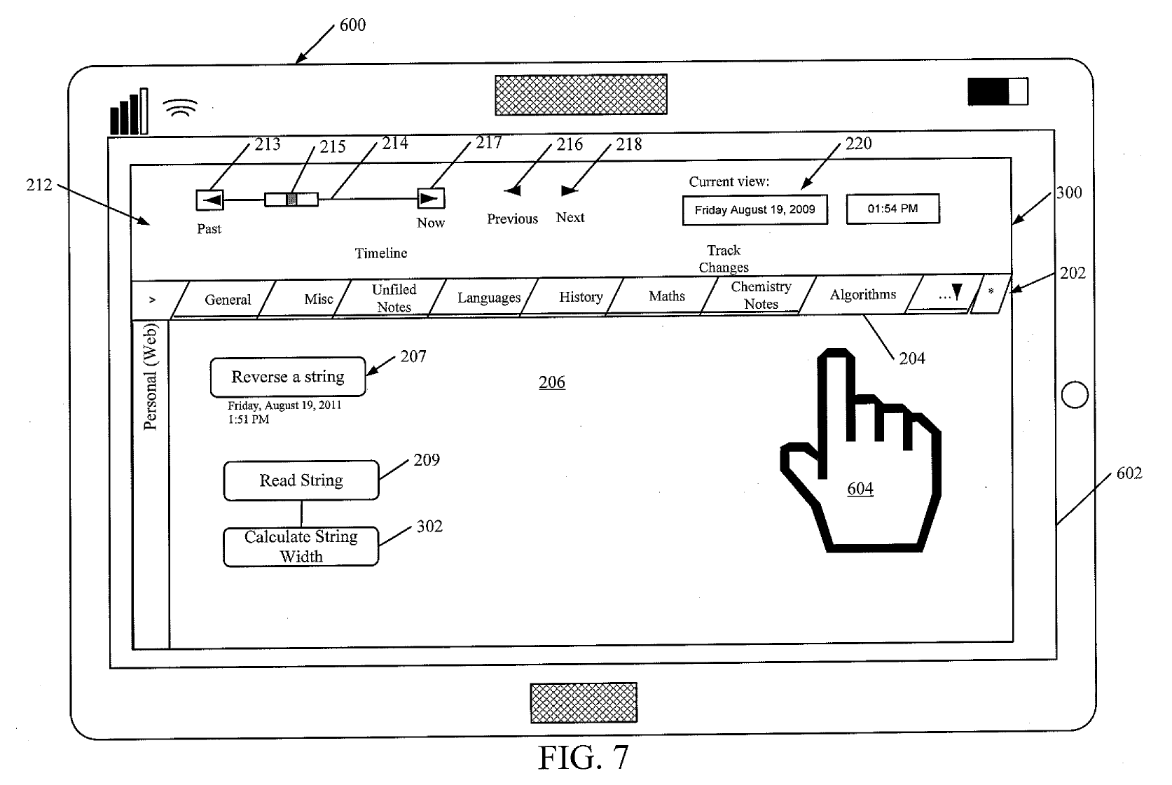

FIGS. 6 and 7 show one embodiment in which device 16 is a tablet computer 600. In FIG. 6, computer 600 is shown with user interface display 200 (from FIG. 3A) displayed on the display screen 602. FIG. 7 shows computer 600 with user interface display 300 (from FIG. 3D) displayed on display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

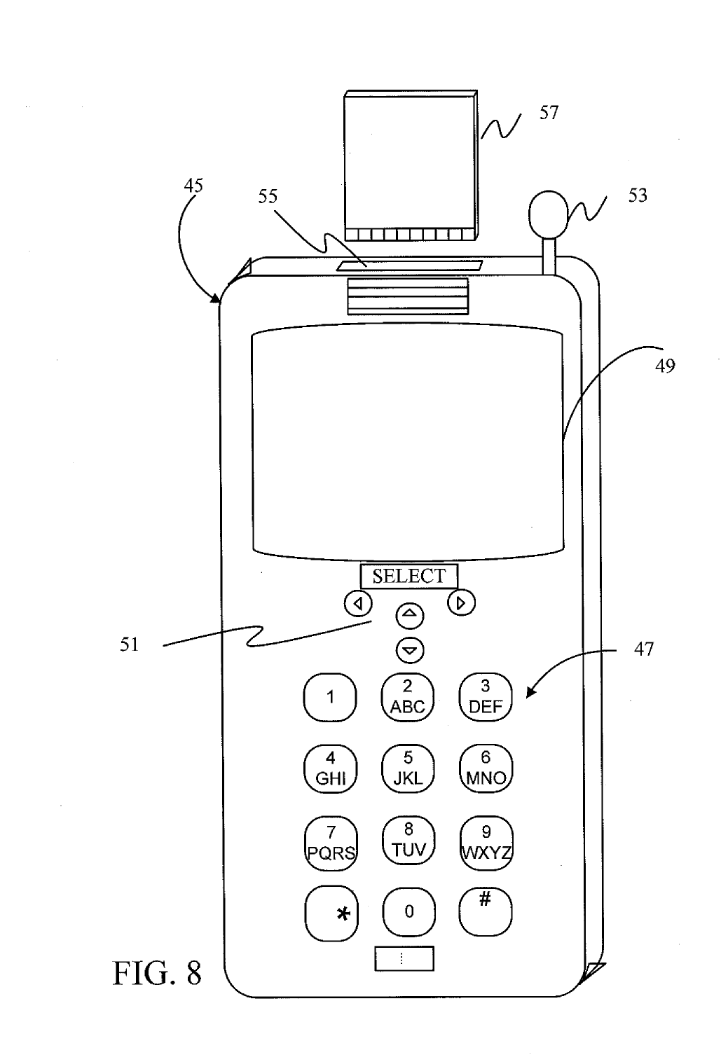

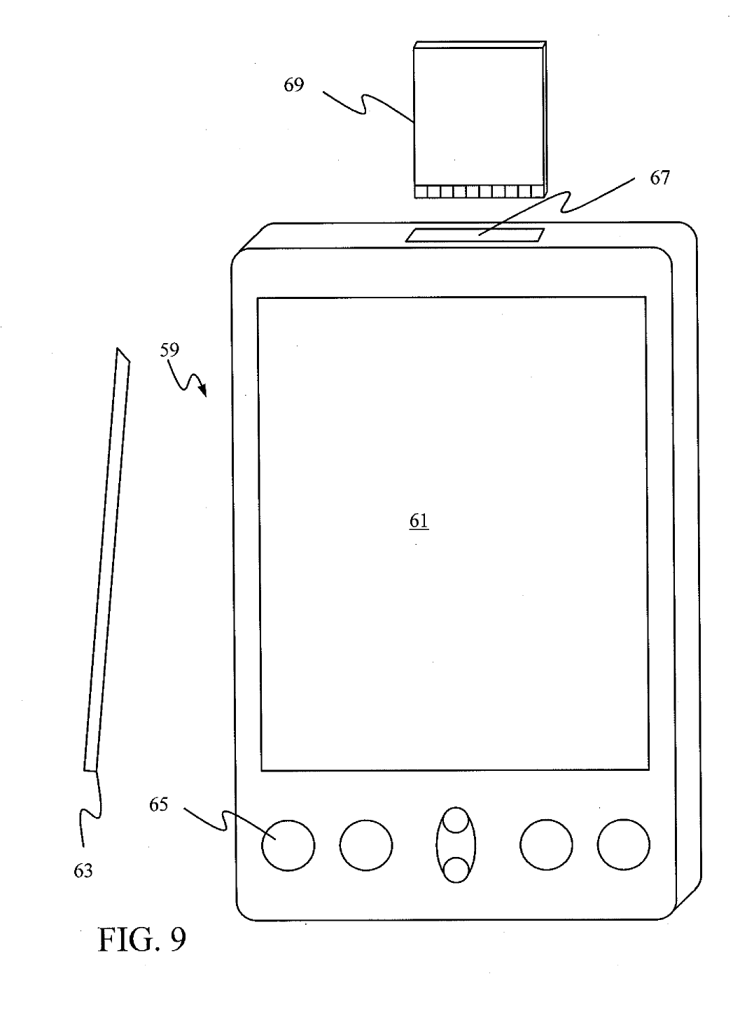

FIGS. 8 and 9 provide additional examples of devices 16 that can be used, although others can be used as well. In FIG. 8, a smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 9 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

Note that other forms of the devices 16 are possible.

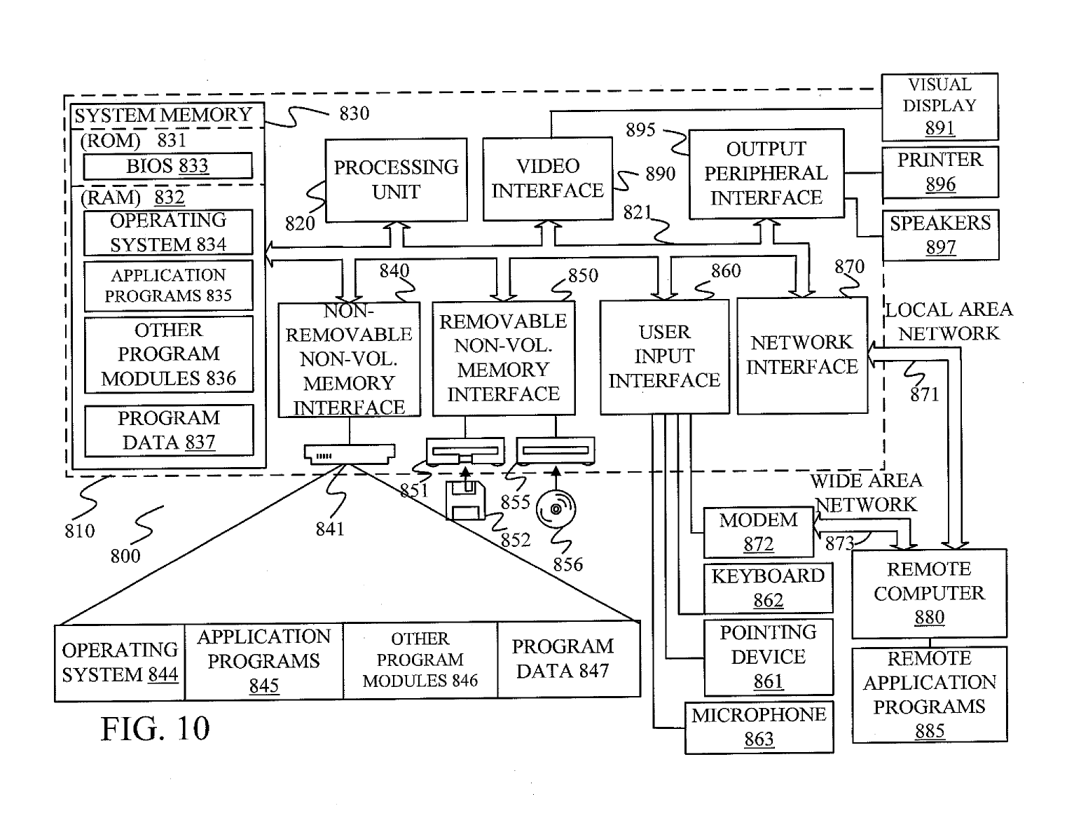

FIG. 10 is one embodiment of a computing environment in which system 100 (for example) can be deployed. With reference to FIG. 10, an exemplary system for implementing some embodiments includes a general-purpose computing device in the form of a computer 810. Components of computer 810 may include, but are not limited to, a processing unit 820 (which can comprise processor 118), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 10 illustrates operating system 834, application programs 835, other program modules 836, and program data 837.

The computer 810 may also include other removable/non-removable volatile/nonvolatile computer storage media. By way of example only, FIG. 10 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 10, provide storage of computer readable instructions, data structures, program modules and other data for the computer 810. In FIG. 10, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 10 illustrates remote application programs 885 as residing on remote computer 880. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of controlling a tracked system, comprising:
displaying a first view of the tracked system corresponding to a first edit instance, within a sequence of edit instances, of the tracked system, the first edit instance identifying a first set of user interface elements displayed at a first time, when the first edit instance is created;
displaying an instance navigation user input mechanism along with the first view of the tracked system;
receiving user manipulation of the instance navigation user input mechanism; and displaying a second view of the tracked system, based on the user manipulation of the instance navigation user input mechanism, the second view corresponding to a second edit instance, within the sequence of edit instances, of the tracked system, the second edit instance identifying a second set of user interface elements displayed at a second time, when the second edit instance is created.

2. The computer-implemented method of claim 1 and further comprising:
prior to displaying the first view, generating the sequence of edit instances, each given edit instance in the sequence identifying a set of user interface elements displayed on a display of the tracked system at a time when the given edit instance is created.

3. The computer-implemented method of claim 2 wherein generating the sequence of edit instances comprises:
generating each edit instance in the sequence by:
determining that a new edit instance is to be generated;
in response, storing the set of user interface elements on the display of the tracked system; and
storing a sequence identifier corresponding to the new edit instance, the sequence identifier indicating that the new edit instance is a most recent edit instance in the sequence.

4. The computer-implemented method of claim 3 wherein storing a sequence identifier corresponding to the new edit instance, comprises:
storing the sequence identifier corresponding to each user interface element in the stored set of user interface elements.

5. The computer-implemented method of claim 3 wherein receiving user manipulation of the instance navigation user input mechanism comprises:
receiving the user manipulation indicative of a move within the sequence to a previous or subsequent edit instance relative to the first edit instance.

6. The computer-implemented method of claim 5 wherein displaying the instance navigation user input mechanism comprises:
displaying a slider movable along a timeline between a first end and a second end, the first end corresponding to a most recent edit instance and the second end corresponding to an initial edit instance.

7. The computer-implemented method of claim 6 wherein receiving user manipulation of the instance navigation user input mechanism comprises:
receiving a user input moving the slider along the timeline to a given position.

8. The computer-implemented method of claim 7 wherein displaying the second view comprises:
identifying the second edit instance as corresponding to the given position on the timeline.

9. The computer-implemented method of claim 5 wherein displaying the instance navigation user input mechanism comprises:
displaying a first user interface button, actuation of the first user interface button being indicative of a user input to display the previous edit instance; and
displaying a second user interface button, actuation of the second user interface button being indicative of a user input to display the subsequent edit instance.

10. The computer-implemented method of claim 9 wherein receiving user manipulation of the instance navigation user input mechanism comprises:
receiving a user input actuating the first or second user interface button.

11. The computer-implemented method of claim 5 and further comprising:
displaying, along with the previous or subsequent edit instance, a date and time indicator indicating a date and time the previous or subsequent edit instance was created.

12. The computer-implemented method of claim 5 wherein the tracked system comprises a multi-page document and wherein displaying the second view comprises:
switching pages from a first page in the multi-page document corresponding to the first view, to a second page in the multi-page document corresponding to the second view; and
displaying the second view of the second page in the multi-page document.

13. The computer-implemented method of claim 1 wherein the tracked system comprises one of a business data system, a social network, or an online portal.

14. The computer-implemented method of claim 3 wherein determining that a new edit instance is to be generated comprises:
receiving edit inputs in the tracked system; and
determining that a new edit instance is to be generated based on the edit inputs.

15. The computer-implemented method of claim 3 wherein determining that a new edit instance is to be generated based on the edit inputs, comprises:
grouping the edit inputs into the new edit instance based on the edit inputs themselves.

16. The computer-implemented method of claim 15 wherein grouping the edit instances comprises:
grouping the edit inputs into the new edit instance based on occurrence of at least one of adding a user interface element to a view, deleting a user interface element from a view, and editing an existing user interface element on a view.

17. A computer-implemented method of accessing information, comprising:
displaying a first view of user interface elements in a document generated by a tracked system at a first time, along with a display sequence user input mechanism, the first view being one of a plurality of different views in a sequence of views;
receiving user manipulation of the display sequence user input mechanism; and
displaying a second view of user interface elements in the document generated by the tracked system at a second time, different from the first time, based on the user manipulation of the display sequence user input mechanism, a difference between the user interface elements in the first and second views reflecting edits made to the document in the tracked system between the first time and the second time.

18. The computer-implemented method of claim 17 wherein displaying the first view comprises:
displaying a sequence identifier indicative of a place of the first view in the sequence of views.

19. The computer-implemented method of claim 17 wherein displaying the first view comprises:
displaying a same set of user interface elements, when displaying the first view, regardless of subsequent deletion or modification of the user interface elements in the document of the tracked system.

20. A computer readable storage medium storing computer readable instructions which, when executed by a computer, cause the computer to perform a method, comprising:
generating a sequence of edit instances, each given edit instance in the sequence identifying a set of user interface elements displayed on a display of a tracked system at a time when the given edit instance is created;
displaying a first view of the tracked system corresponding to a first edit instance, within the sequence of edit instances, of the tracked system, the first edit instance identifying a first set of user interface elements displayed at a first time, when the first edit instance is created;
displaying an instance navigation user input mechanism along with the first view of the tracked system;
receiving user manipulation of the instance navigation user input mechanism; and
displaying a second view of the tracked system, based on the user manipulation of the instance navigation user input mechanism, the second view corresponding to a second edit instance, within the sequence of edit instances, of the tracked system, the second edit instance identifying a second set of user interface elements displayed at a second time, when the second edit instance is created.
